(19) United States
(12) Patent Application Publication
(10) Pub. No.: US 2018/0362279 A1
(43) Pub. Date: Dec. 20, 2018

(54) WEB-WOUND ROLLS WITH WEB EDGE TREATMENT BY PRINTABLE ADHESIVE COMPOSITIONS

(71) Applicant: 3M INNOVATIVE PROPERTIES COMPANY, St. Paul, MN (US)

(72) Inventors: Yuko Yoshida, Tokyo (JP); Yorinobu Takamatsu, Kanagawa Pref. (JP); Daniel J. Theis, Mahtomedi, MN (US); Richard J. Pokorny, Maplewood, MN (US); Christine M. Andres, Ann Arbor, MI (US)

(21) Appl. No.: 16/072,684

(22) PCT Filed: Jan. 20, 2017
(86) PCT No.: PCT/US2017/014248

§ 371 Date: Jul. 25, 2018

Related U.S. Application Data
(60) Provisional application No. 62/288,557, filed on Jan. 29, 2016.

(51) Int. Cl. B65H 18/28; C09D 11/101; C09J 133/08; B32B 7/14; B32B 7/06

(52) U.S. Cl. CPC B65H 18/28; C09D 11/101; C09J 133/08; B32B 7/14; B65H 2701/1752; B65H 2301/4127; B65H 2301/414324; B65H 2601/2531; B65H 2519/00; B32B 7/06

(57) ABSTRACT

Web-wound rolls with a web edge treatment by printable adhesive compositions and processes to make the same are provided. The web-wound rolls include a substrate web having at least two web edges. One or more quantities of adhesive are disposed and subsequent curing adjacent to one or both of the web edges. The substrate web is wound upon itself in multiple revolutions about a central core, and each revolution is held substantially separate from the next by the adhesive.

### TECHNICAL FIELD

The present disclosure relates to web-wound rolls having a web edge treatment with a printed adhesive region, and processes to make the same.

### BACKGROUND

Winding impression defects are very common in a web-wound roll process for winding or rolling continuous films or webs. An inside pressure distribution of a web-wound roll can be made by, for example, surface roughness of the roll core, wrinkles, foreign matters, etc., which can generate impression defects and/or film deformation. Various approaches have been described in, for example, PCT Publication No. WO 2011030684 (Maeda), and Japanese Patent Application Publication Nos. JP 201346966 and JP 2012247727 to reduce the winding impression defects.

### SUMMARY

There is a desire to reduce winding impression defects in web-wound roll processes. While soft winding can be effective to reduce winding impression defects, soft winding may generate telescoping issues. The present disclosure provides soft winding processes for forming web-wound rolls that does not generate telescoping issues. The term “soft winding process” used herein refers to a web-wound roll process with a winding tension, for example, not greater than 2 N/cm, typically between 0.01 N/cm and 2 N/cm.

Briefly, in one aspect, the present disclosure describes an article including a continuous web that includes a substrate having a first major side and a second major side opposite to the first major side, and at least two web edges. One or more discrete quantities of adhesive are disposed on one or both of the first and second major sides and adjacent to one or both of the web edges. The substrate is rolled upon itself in multiple revolutions, and each revolution is held substantially separate from the next by the one or more stripes of adhesive dots.

In another aspect, the present disclosure describes a method of forming a wound web. The method includes providing a continuous web including a substrate having a first major side and a second major side opposite to the first major side and at least two web edges, dispensing a curable ink composition in discrete quantities on one or both of the first and second major sides and adjacent to one or both of the web edges, curing the ink composition to form one or more discrete quantities of adhesive, and winding the substrate upon itself in multiple revolutions. Each revolution is held substantially separate from the next by the one or more discrete quantities of adhesive.

In another aspect, the present disclosure describes an ink-jet printable composition of matter capable of being UV cured into a pressure sensitive adhesive. The composition includes i) between about 50 to 99.89 parts by weight of hydroxyalkyl acrylate having 2 to 6 carbon alkyl, ii) between about 0 to 49.89 parts by weight of ethylenically unsaturated monomer including one or more of vinyl, acrylate, and (meth)acrylate monomer, iii) between about 0.01 to 5.0 parts by weight of a multi-functional acrylate or oligomer having (meth)acryl functional groups, and iv) between about 0.1 to 10 parts by weight of a photo-initiator. The viscosity of the composition is between about 1 to 50 mPa-s, and the surface tension of the composition is between about 20 to 40 dyn/cm. In some embodiments, the hydroxyalkyl acrylate can be or include 4-hydroxybutyl acrylate (4-HBA).

In yet another aspect, the disclosure provides method of forming an array of adhesive dots on a substrate. The method includes providing the above ink-jet printable composition, dispensing one or more discrete quantities of the ink-jet printable composition onto the substrate with an ink-jet printer, and exposing the quantities of the ink-jet printable composition to ultraviolet (UV) radiation, forming the array of adhesive dots.

An improvement in soft winding processes is disclosed in copending and co-assigned patent application PCT US2015/066089 (Yoshida et al.), “Web-Wound Rolls with Microsphere Treated Edge and Methods of Making Same.” The present disclosure provides a simplified process made possible by the discovery of a printable (e.g., ink-jet printable) composition. In some embodiments, the printable composition can be cured in situ into an adhesive (e.g., pressure sensitive adhesive or PSA) that has sufficient tackiness and with sufficient cohesion to separate one revolution in a web-wound roll from the next.

Various unexpected results and advantages may be obtained in exemplary embodiments of the disclosure. One such advantage of exemplary embodiments of the present disclosure is that continuous films or webs can be wound by a soft winding process without generating any significant telescoping issues. In contrast, conventional approaches such as, for example, taper reducing tension, knurling of roll edge, insertion of spacer, or the combinations thereof, may not achieve the advantages of the present disclosure. For example, while a process using taper reducing wind tension control may be effective to reduce the winding impression, the effect of such process is limited by factors of web handling which depends on the web properties and equipment capability. While knurling on both web edges may provide the space between adjacent layers of wounded film and may reduce the inner pressure thereof, it is difficult to obtain stable knurling process with thin films or webs since it is easy to create critical damages on web edges. While insertion of spacer at both web edges may reduce the inner wound pressure, it would be difficult to control the position, thickness, and/or flexibility of spacer to achieve the effects.

Various aspects and advantages of exemplary embodiments of the disclosure have been summarized. The above Summary is not intended to describe each illustrated embodiment or every implementation of the present certain exemplary embodiments of the present disclosure. The Drawings and the Detailed Description that follow more particularly exemplify certain preferred embodiments using the principles disclosed herein.

### BRIEF DESCRIPTION OF THE DRAWINGS

The disclosure may be more completely understood in consideration of the following detailed description of various embodiments of the disclosure in connection with the accompanying figures, in which:

FIG. 1 is a perspective side view of a web-wound roll, according to one embodiment.

FIG. 2 is a cross sectional view of a portion of the web-wound roll of FIG. 1.

FIG. 3 is a cross sectional view of a liner film having dot printed adhesive, according to one embodiment.

FIG. 4 is a cross sectional view of a printed adhesive dot, according to one embodiment.

FIG. 5 is a schematic diagram of a process for forming a web-wound roll, according to one embodiment.

FIG. 6 is a schematic diagram of a process for printing adhesive dots by an ink-jet printer, according to one embodiment.

FIG. 7 are photomicrographs providing visual standards for the outcomes recited in Table 1.

In the drawings, like reference numerals indicate like elements. While the above-identified drawing, which may not be drawn to scale, sets forth various embodiments of the present disclosure, other embodiments are also contemplated, as noted in the Detailed Description. In all cases, this disclosure describes the presently disclosed disclosure by way of representation of exemplary embodiments and not by express limitations. It should be understood that numerous other modifications and embodiments can be devised by those skilled in the art, which fall within the scope and spirit of this disclosure.

### DETAILED DESCRIPTION

The present disclosure provides printable ink compositions and web-wound rolls having a web edge treatment with an adhesive generated from the compositions, and processes to make the same. Some films or webs described herein can be wound by soft winding processes that are effective to reduce winding impression defect without generating telescoping issues.

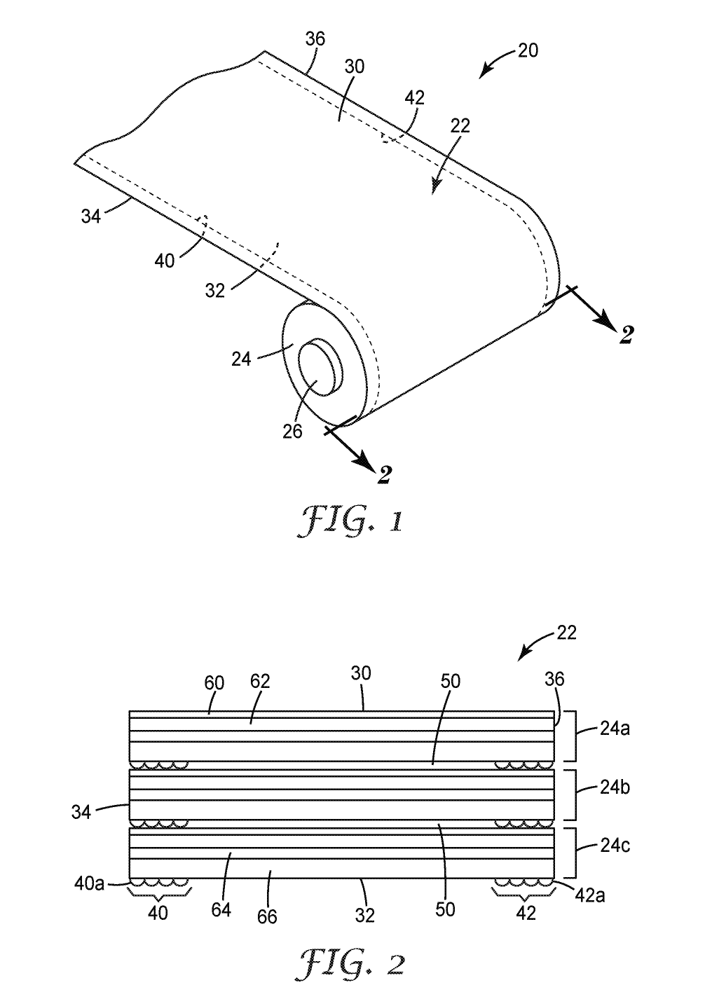

FIG. 1 illustrates a perspective view of a web-wound roll 20. The web-wound roll 20 includes a continuous web 22 of indefinite length material. The continuous web 22 is wound upon itself by a soft winding process in multiple revolutions 24, conveniently around a central core 26. FIG. 2 is a cross section view of several of the wound revolutions 24, taken along section lines 2-2 in FIG. 1.

In some embodiments, the soft winding process uses a winding tension, for example, not less than 0.01 N/cm, not less than 0.05 N/cm, not less than 0.07 N/cm, or not less than 0.1 N/cm. In some embodiments, the soft winding process uses a winding tension, for example, not greater than 2 N/cm, not greater than 1 N/cm, not greater than 0.5 N/cm, or not greater than 0.2 N/cm. In some embodiments, the soft winding process uses a winding tension between 0.01 N/cm and 2 N/cm, between 0.05 N/cm and 1 N/cm, or between 0.1 N/cm and 0.5 N/cm. The continuous web 22 has a first major side 30 and a second major side 32 opposite to the first major side 30, and two web edges 34 and 36 substantially parallel with each other. The continuous web 22 has a width W1 defined between the web edges 34 and 36. In some embodiments, the width W1 can vary from several centimeters to several meters dependent on desired applications.

In some embodiments, the continuous web 22 can include one or more layers of flexible (co)polymeric material. In some embodiments, the continuous web 22 can be a multi-layer optically clear laminate suited for attachment to, for example, window glass. One exemplary multi-layer optically clear laminate is described in U.S. Pat. No. 7,238,401 (Dietz) which is incorporated herein by reference.

Two zones 40 and 42 are adjacent to web edges 34 and 36 on the second major side 32. The zones 40 and 42 each are continuous and extend along the respective web edges 34 and 36 with a width W2. In some embodiments, the width ratio W2/W1 of the zone 40 or 42 and the web 22 can be, for example, not less than 0.01, not less than 0.02, or not less than 0.05. In some embodiments, the ratio of W2/W1 can be, for example, not greater than 0.3, not greater than 0.2, or not greater than 0.1. In some embodiments, the ratio of W2/W1 can be, for example, between 0.01 and 0.2, between 0.02 and 0.2, or between 0.05 and 0.2. In some embodiments, the zones 40 or 42 can be disposed immediately adjacent to the respective web edge 34 or 36. In other embodiments, the zones 40 or 42 can be spaced apart from the respective web edge 34 or 36 with a distance of, for example, not greater than the width W2. It is to be understood that the zone 40 or 42 may not have a uniform width W2 along the respective web edge 34 or 36. In some embodiments, the zones 40 and 42 each can include more than one array of dots of pressure sensitive adhesive 40a and 42a extending along the respective web edges 34 and 36. The as cured thickness of the dots of pressure sensitive adhesive can be, for example, not less than 0.1 microns, not less than 0.5 microns, or not less than 1 micron. The thickness of the dots can be, for example, not greater than 200 microns, not greater than 100 microns, or not greater than 50 microns. In some embodiments, the thickness of the dots can be, for example, from 0.5 microns to 100 microns.

As shown in FIG. 2, within the zones 40 and 42 are arrays of quantities of adhesive 40a and 42a, respectively. The adjacent quantities of adhesive can be discrete. In some embodiment, the quantities of adhesive 40a and 42a can be conveniently present in the form of discrete dots or short intermittent stripes. At least some of the adhesive dots are disconnected with respect to each other with a gap between nearest neighbors. In some embodiments, the gap may be, for example, no less than 0.1 times, no less than 0.2 times, no less than 0.5 times, no less than 1 time, or no less than 2 times of the average diameter of the adhesive dots. In some embodiments, some of the adhesive dots may slightly overlap with the nearest neighbors.

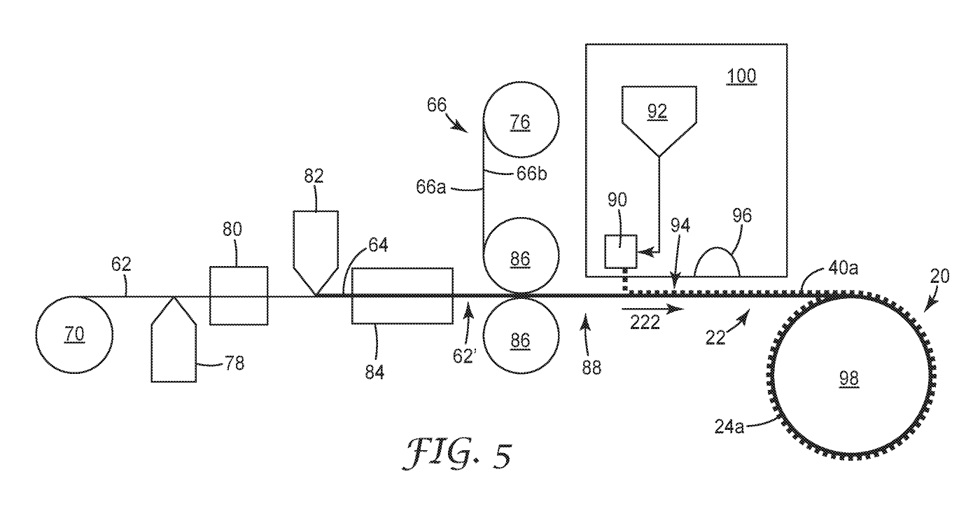

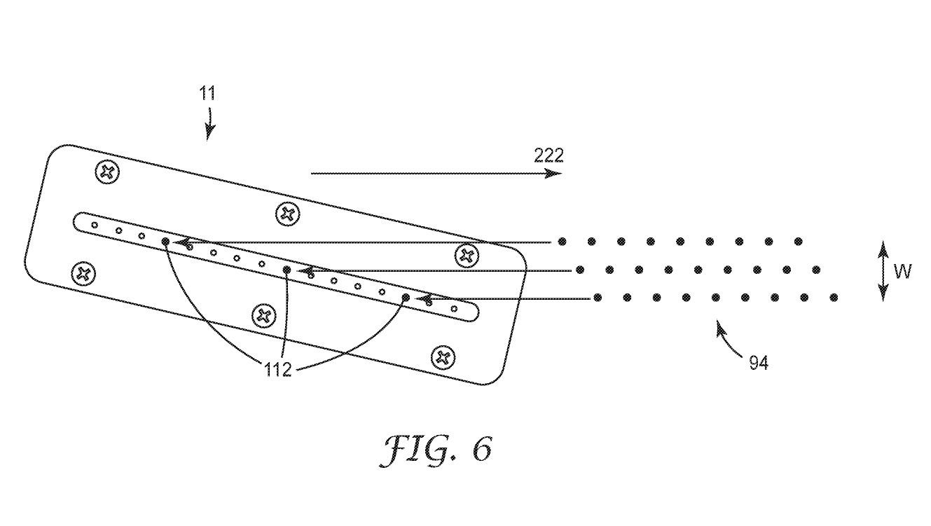

The quantities of adhesive each may have various in-plane shapes including, for example, a circular shape, an oval shape, a polygonal shape, an irregular shape, etc. The ratio of the longest and shortest dimensions of the in-plane shape can be, for example, no greater than 10, no greater than 5, no greater than 3, no less than 2, or about 1. The array of adhesive dots extends along a machine direction (e.g., a web running direction 222 of FIG. 5), and can form any suitable patterns. In some embodiments, the adhesive dots 40a or 42a may uniformly distributed within the respective zones 40 and 42.

The quantities of adhesive 40a and 42a can be deposited on the web 22 by suitable processes such as a printing process including, for example, gravure printing, flexography, screen printing, and inkjet printing, etc. In some embodiments, at least some quantities of adhesive 40a and 42a can be preferably printed in a discrete form instead of a consecutive form (e.g., consecutive lines). Consecutive quantities of adhesive may disturb the movement of air or web stress and may produce a hard-band deformation on a web when the web is wound.

In some embodiments, the one or more arrays of quantities of adhesive 40a or 42a can be disposed on one or both of the first and second major sides 30 and 32, adjacent to the web edge 34 or 36, such as in the zone 40 or 42. In one embodiment, the arrays of quantities of pressure sensitive adhesive can be disposed on the first major side 30. In another embodiment, one array can be disposed on the first major side 30 adjacent to the web edge 34 and another array can be disposed on the second major side 32 adjacent to the web edge 36. In yet another embodiment, one or more arrays of quantities of pressure sensitive adhesive can be disposed only adjacent to one of the web edges 34 and 36.

The quantities of adhesive 40a and 42a can be sufficiently tacky to prevent possible telescoping defects when the web-wound roll 20 is soft wound. In some embodiments, the arrays of quantities of adhesive 40a and 42a can be disposed on the web by printing a printable adhesive composition thereon. In some embodiments, one or more quantities of curable adhesive composition can be provided by disposing a printable composition of matter. The printed composition can be cured to form the arrays of quantities of adhesive 40a and 42a. In some embodiments, the printable adhesive composition can curbed by radiation such as, for example, ultraviolet (UV) radiation into a pressure sensitive adhesive (PSA) within the zones 40 and 42.

In some embodiments, the printable adhesive composition may include i) 50 to 99.89 parts by weight of hydroxyl alkyl acrylate having 2 to 6 carbon alkyl including, for example, one or more of 2-hydroxyethylacrylate, 2-hydroxypropylacrylate, 3-hydroxyproylacrylate, 2-hydroxybutylacrylate, 4-hydroxybutylacrylate (4-HBA), 6-hydroxyhexylacrylate, etc.; ii) between about 0 to 49.89 parts by weight of ethylenically unsaturated monomer such as, for example, vinyl, acrylate, (meth)acrylate monomer; iii) about 0.01 to 5.0 parts by weight of a multi-functional acrylate or oligomer having (meth) acryl functional groups; and iv) between about 0.1 to 10 parts by weight of a photo-initiator.

Examples of ethylenically unsaturated monomer may include one or more of:

alkyl (meth)acrylates having straight-chain, branched, or cyclic alkyl groups having from 2 to 22 carbon atoms, such as, for example, ethyl (meth)acrylate, n-butyl (meth)acrylate, hexyl (meth)acrylate, n-octyl (meth)acrylate, 2-ethylhexyl (meth)acrylate, isobutyl (meth)acrylate, tert-butyl (meth)acrylate, cyclohexyl (meth)acrylate, isobornyl (meth)acrylate, dicyclopentanyl (meth)acrylate;

alkoxy (meth)acrylate such as, for example, methoxyethyl(meth)acrylate, ethoxyethyl(meth)acrylate, butoxyethyl(meth)acrylate, ethylcarbitol (meth)acrylate, 2-ethylhexylcarbitol (meth)acrylate;

aromatic (meth)acrylate such as, for example, phenoxyethyl(meth)acrylate, phenoxyethyl polyethylene glycol (meth)acrylate, nonylphenoxy polyethylene glycol (meth)acrylate, benzyl(meth)acrylate;

other (meth)acrylate such as, for example, polycaprolactone mono(meth)acrylate, tetrahydroflufuryl (meth)acrylate;

olefins such as, for example, ethylene, butadiene, isoprene, and isobutylene;

vinyl monomers such as, for example, vinyl acetate, vinyl propionate, and styrene;

carboxyl group-containing monomers such as, for example, (meth)acrylic acid, itaconic acid, maleic acid, fumaric acid, crotonic acid, and isocrotonic acid or anhydrides thereof (maleic anhydride or the like);

amide group-containing monomers such as, for example, N-vinyl caprolactam, N-vinyl pyrrolidone, (meth)acrylamide, N-methyl (meth)acrylamide, N,N-dimethyl (meth)acrylamide, and N-octyl (meth)acrylamide; and

amino group-containing monomers such as, for example, N,N-dimethylaminoethyl (meth)acrylate, N,N-diethylaminoethyl (meth)acrylate, and N,N-dimethylaminoethyl (meth)acrylamide.

Examples of multifunctional (meth)acrylate may include one or more of 1,4-butanediol di-(meth)acrylate, 1,6-hexanediol di-(meth)acrylate, neopentylglycol di-(meth)acrylate, 1,9-nonanediol di-(meth)acrylate, tricyclodecane dimethylol di-(meth)acrylate, trimethylolpropane tri-(meth)acrylate, pentaerithritol tri- and/or tetra-(meth)acrylate, ditrimethylolpropane tetra-(meth)acrylate, dipentaerithritol penta- and/or hexa-(meth)acrylate.

Examples of oligomer having (meth) acryl functional groups may include one or more of (meth)acrylated urethanes (e.g., urethane (meth)acrylates), (meth)acrylated epoxies (e.g., epoxy (meth)acrylates), (meth)acrylated polyesters (e.g., polyester (meth)acrylates), (meth)acrylated (meth)acrylics, (meth)acrylated polyethers (e.g., polyether (meth)acrylates), and (meth)acrylated polyolefins.

Examples of photo-initiator may include one or more of:

2-hydroxy-2-methyl-1-phenylpropane-1-one (e.g., available from Ciba Specialty Chemicals under the trade designation Darucur 1173); 1-Hydroxy-cyclohexyl-phenylketon (e.g., available from Ciba Specialty Chemicals under the trade designation Irgacure 184); 2-Hydroxy-1-{4-[4-(2-hydroxy-2-methylpropionyl)-benzyl]-phenyl}-2-methylpropane-1-one (e.g., available from Ciba Specialty Chemicals under the trade designation Irgacure 127); 1-[4-(2-hydroxyethoxy)-phenyl]-2-hydroxy-2-methyl-1-propane-1-one (e.g., available from Ciba Specialty Chemicals under the trade designation Irgacure 2959); 2,2-dimethoxy-1,2-diphenylethane-1-one (e.g., available from Ciba Specialty Chemicals under the trade designation Irgacure 651); 2-benzyl-2-dimethylamino-1-(4-morpholinophenyl)-1-butanone (e.g., available from Ciba Specialty Chemicals under the trade designation Irgacure 369); 2-methyl-1-[4-(methylthio)phenyl]-2-morpholino-1-propanone (e.g., available from Ciba Specialty Chemicals under the trade designation Irgacure 907); bis(2,4,6-trimethylbenzoyl)-phenylphosphine-oxide (e.g., available from Ciba Specialty Chemicals under the trade designation Irgacure 819); 2,4,6-trimethylbenzoyl-diphenylphosphine-oxide (available from Ciba Specialty Chemicals under the trade designation Darocur TPO); Camphorquinone available from Tokyo Chemical Industry Co., Ltd.); Benzophenone (e.g., under the trade designation KAYACURE BP-100 available from Ciba Specialty Chemicals); and 2,4-Diethylthioxanthone (e.g., under the trade designation KAYACURE DETX-S available from Nippon Kayaku Co., Ltd.).

Printable adhesive compositions described herein may have desired properties including, for example, low viscosity, low glass transition temperature (Tg), high reactivity, moderate hydrophilicity, etc. Suitable hydroxyl alkyl acrylate can be selected to make the composition suitable for specific printing processes. In some embodiments, the selected hydroxyl alkyl acrylate may have a Tg, for example, below −25° C. The present disclosure found that some acrylate monomers that are more conventional monomer for pressure sensitive adhesives (PSA) may exhibit low curing reactivity. Such conventional monomer may include, for example, 2-ethylhexylacrylate and butyl acrylate that have a low Tg. Conventional UV curable oligomers that exhibit high reactivity have viscosities that may be too high for an ink-jet printing process. Acrylate monomers having a hydroxy group, such as 2-hydroxyethylacrylate (2-HEA) and 2-hydroxypropylacrylate (2-HPA) may exhibit high UV reactivity and a Tg less than 0° C., and may be hydrophilic that the pressure sensitive adhesive (PSA) formed from curing them may have poor water resistance, which may make the formed PSA not suitable for some soft winding applications where wound rolls may be stored for some time. In some embodiments, 4-hydroxybutylacrylate (4-HBA) has been discovered to possess desired properties for ink jet printing such as, for example, low viscosity, low Tg, high reactivity, and moderate hydrophilicity. For example, 4-hydroxybutylacrylate itself is an acrylate or monomer having a Tg below −25° C., and up to 99.89 of the printable ink composition can be the 4-hydroxybutylacrylate.

Other components can be used for a printable ink composition, provided their inclusion does not interfere with the need to be printable (e.g., ink-jet printable). The addition components can include, for example, modifiers such as rheology modifiers, colorants, fillers and other (co)polymeric additives. When such modifiers are used, the amounts used in the adhesive mixture are amounts effective for the known uses of such modifiers.

In some embodiments, the viscosity of the printable adhesive composition may be, for example, between about 1 to about 50 mPa-s. In some embodiments, the surface tension of the printable composition may be, for example, between about 10 to about 50 dyn/cm, between about 20 to about 40 dyn/cm, or more preferably between about 23 to about 40 dyn/cm. In some embodiments, the printable composition can be converted to a cured adhesive having a glass transition temperature (Tg), for example, in a range of about −80° C. to about 25° C. In some embodiments, the composition is ink-jet printable and the ink-jet printed composition can be cured to form a pressure sensitive adhesive by UV radiation, and the pressure-sensitive adhesive can have a Tg of, for example, no greater than 25° C., which usually indicative of sufficient tackiness for the purpose of soft winding.

Referring again to FIG. 2, a cross section view of several of the wound revolutions 24, taken along section lines 2-2 in FIG. 1, is depicted. In this view it can be appreciated that each of revolutions 24a, 24b and 24c of the continuous web 22 is held substantially separate from the next by the arrays 40 and 42 of respective adhesive dots 40a and 42a. Spaces 50 can be created between adjacent revolutions 24a, 24b and 24c. It is to be understood that in some embodiments, one or more adhesive dots 40a and 42a can be provided between zones 40 and 42, for example, inside the spaces 50 to keep the adjacent revolutions separate.

The continuous web 22 of FIGS. 1 and 2 can be an optical film where any scratches or defects such as winding impression defects and/or film deformation may be plainly visible therein with the naked eye when viewed under, for example, fluorescent lights at a distance of about 0.5 m. In the embodiment of FIG. 2, the continuous web 22 is a laminate that includes an upper layer 60, (e.g., a hard coat) adhered to a (co)polymeric film 62 which is laminated to a release liner 66 by an optically clear adhesive (OCA) 64.

In some embodiments, the upper layer 60 may be obtained by applying, e.g. any commercially available hard coating composition to the surface of the (co)polymeric film 62, as the case may be, provided that the resultant hard coat layer dries to form a scratch-resistant surface. The hard coating composition can be, for example, a ceramer coating composition containing an organic resin and silica particles as described in U.S. Pat. No. 5,677,050 (Bilkadi et al.). In some embodiments, the hard coating composition may include about 20% to about 80 wt % of ethylenically unsaturated monomers, about 10 wt % to about 50 wt % of acrylate functionalized colloidal silica, and about 5 wt % to about 40 wt % of N,N-disubstituted acrylamide monomer or N-substituted-N-vinyl-amide monomer. The coating can then be cured to provide an abrasion-resistant, light transmissive ceramer coating on the top film lamina of the laminate. The hard coating is preferably applied to the film before it is used to form the laminate.

In some embodiments, the (co)polymeric film 62 may include any suitable polymeric material. The polymeric material can be nonadhesive and may be formed into a sheet which is of substantially uniform thickness along its entire area and is optically clear with substantially no surface imperfections which might interfere with optically clarity. The term “nonadhesive” means that the polymeric material used to form the film is not an adhesive type material such as conventionally used to make glass or layered film laminates. Such adhesive polymeric materials would include thermoplastic adhesive materials such as polyvinyl butyral, ethylene terpolymers, epoxies, polyurethanes, silicones and acrylic polymers. In one embodiment, the polymeric film 62 is a polyethylene terephthalate (PET) film. The (co)polymeric film 62 may vary in thickness not less than 0.5 mil (0.013 mm), not less than 1 mil (0.025 mm), or not less than 1.5 mils (0.038 mm). The (co)polymeric film 62 may vary in thickness not greater than 20 mils (0.508 mm), not greater than 10 mils (0.254 mm), or not greater than 5 mils (0.127 mm). The (co)polymeric film 62 may vary in thickness from about 0.5 mil to about 10 mils (0.013 to 0.25 mm), but preferably do not exceed about 5 mils (0.13 mm) in thickness. The (co)polymeric film 62 may be made of polymeric material such as polyethylene-terephthalate (PET) which when formed into a sheet, biaxially oriented and heat set provides a high breaking strength film with excellent optical properties. In some embodiments, the polymeric films can be primed or corona treated to improve adhesion between coatings and adhesive layers.

In some embodiments, the optically clear adhesive (OCA) 64 between the (co)polymeric film 62 and the release liner 66 may include any relatively soft pressure sensitive adhesive material that can be optically clear, for example, having a transmittance not less than 50% in the visible wavelength range. The pressure sensitive adhesive material may, itself, not be optically clear in a free standing condition but once incorporated into the laminate can have an optically clear condition and sufficient adhesion to maintain the layers of the laminate in an unaltered form over any of a wide variety of climatic conditions. The pressure sensitive adhesive compositions can be based on acrylate or acrylic copolymers and terpolymers. The thickness of the optically clear adhesive (OCA) 64 may vary, for example, from about 0.1 mil to about 1 mil (0.003 to 0.025 mm).

In some embodiments, the release liner 66 may include any conventional sheet material. The release liner 66 provides protection for the exposed surface of the optically clear adhesive (OCA) 64. The release liner 66 may have temporary weak adhesion to the surface of optically clear adhesive (OCA) 64 to which it is applied, and thus can strip cleanly from the surface to leave behind an undamaged layer of adhesive for attachment to the surface of, for example, a glass sheet.

As shown in FIG. 2, the arrays 40 and 42 of quantities of adhesive are deposited along the respective web edges 34 and 36 on the surface of the release liner 66 of one revolution and in contact with the upper layer 60 of the adjacent revolution. Conveniently, the arrays 40 and 42 of quantities of adhesive are capable of adhering to the surface of the release liner 66. In some embodiments, when the optical film is under use, for example, for attachment to window glass, the release liner 66 can be removed and the arrays 40 and 42 of quantities of adhesive can be removed along with the release liner 66. In some embodiments, the web edges 34 and 36 along with the arrays 40 and 42 of quantities of adhesive can be trimmed before the use of the optical film.

FIG. 3 illustrates a cross sectional view of the release liner 66 having multiple arrays 40, 42 and 44 of quantities of adhesive disposed on a major surface 66b thereof. The release liner 66 can be divided into a plural number in a converting process, for example, by cutting the release liner 66 into two along a middle line 666.

The release liner can be any suitable kind film such as, for example, poly-ethylene-terephthalate (PET), polyethylene naphthalate (PEN), polysulfone, polyether sulfone (PES), polystyrene, polyacrylate, polyetheretherketone, polycarbonate, polyethylene (PE), polypropylene (PP), polyamide, polyimide, nylon, triacetylcellulose, cellulose diacetate, polyalkyl ether methacrylate, Acrylates copolymer, polymethyl methacrylate, polytetrafluoroethylene (PTFE), polytrifluoroethylene, polyvinyl chloride (PVC), poly vinyl chloride co vinyl acetate, polyvinyl alcohol, cellophane, Cellulose plastics and others.

A release material can be coated on a release surface 66a opposite to the major surface 66b. Suitable release coating materials may include, for example, silicone, fluorocarbon, polyurethane, polyacrylate, etc.

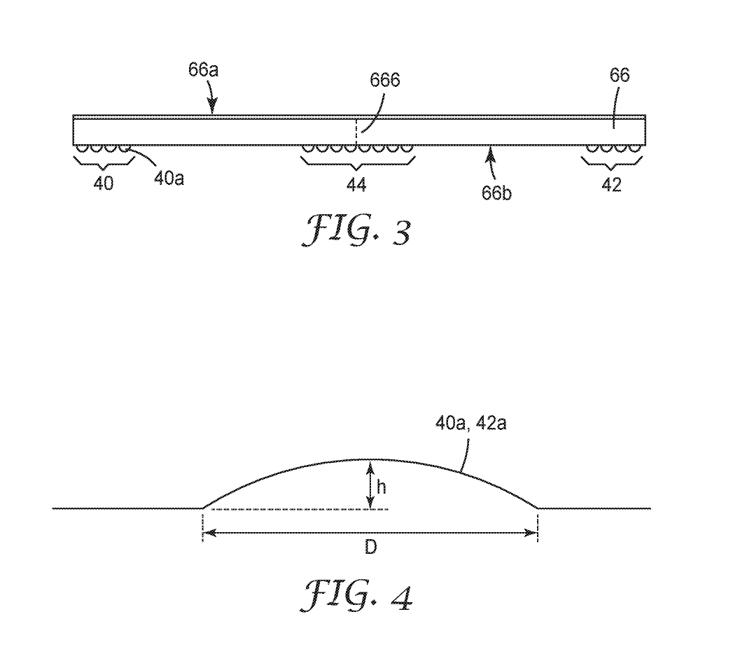

In some embodiments, the quantities of adhesive 40a and 42a in FIGS. 2 and 3 may present in form of dots each having a cross-sectional dome shape as shown in FIG. 4. The dots can have an average diameter “D” in a range of, for example, between about 10 microns to about 5 mm, an average height “h” in a range of, for example, between about 5 microns to about 2 mm. In some embodiments, the average diameter “D” may be at least one time, 1.5 times, or 2 times of the average height “h”. The shape of the quantities of adhesive 40a and 42a can be substantially retained after the winding of a web.

Referring now to FIG. 5, a schematic diagram of one possible process for forming a web-wound roll such as the web-wound roll 20 of FIG. 1, according to the present disclosure is depicted. The (co)polymeric film 62 is unwound from a unwind stand 70. The (co)polymeric film 62 may conveniently include a polyester such as that available from DuPont Teijin Films of Osaka, JP under the trade designation MELINEX 454-200. The (co)polymeric film 62 receives a coating of hard coat material from a coater 78 to provide a wet coating of hard material which is dried by passing through a drier 80 to form the hard coat 60 of FIG. 2. The coater 78 can be any convenient coating device such as one including a slot die to provide a uniform coating to the surface of the (co)polymeric film 62. The drier 80 can be any convenient drying or curing device such as, for example, a tunnel oven or a curing station using a UV source. The coating solution can be any commercially available hard coating solution which has appropriate viscosity to make it coatable.

Then, the optically clear adhesive 64 is coated by another coater 82 on the opposite side of the (co)polymeric film 62 and dried by a drier 84. The coating solution can be any convenient solution of a pressure sensitive adhesive. The release liner 66 is provided on an unwind stand 76. In the depicted embodiment, the release liner 66 has the first side 66a that may have been treated to possess release properties, and the second side 66b which may be left untreated. The twice coated substrate 62′ and the release liner 66 are brought together as at a laminating station 86 and laminated together. The laminated material, together defining the web 22, is conveyed to a winding stand 98, where the continuous web 22 is wound to form the web-wound roll 20.

One or more quantities of adhesive composition can be provided on the second side 66b of the release liner 66. In the depicted embodiment of FIG. 5, the laminated material 88 is conveyed along a machine direction 222 past an ink-jet printing station 90, which is supplied by a source of ink-jet printable composition 92. The ink-jet printing station 90 deposits at least one array 94 of quantities of ink-jet printable composition 92, conveniently in the form of dots or short intermittent stripes.

The laminated material 88 is then conveyed past a UV curing station 96, where the array 94 is converted into quantities of adhesive 40a. A curing process may slightly (e.g., less than 10%, 5%, or 1%) change the dimensions of the printed adhesive. The finished continuous web 22 is then wound up on the wind-up stand 98, forming successive revolutions (24a, 24b, and 24c in FIG. 2) of web-wound roll 20. In some embodiments, the printing station 90, a supplier for providing the composition 92, and the curing station 96 can be integrated as a printing unit 100.

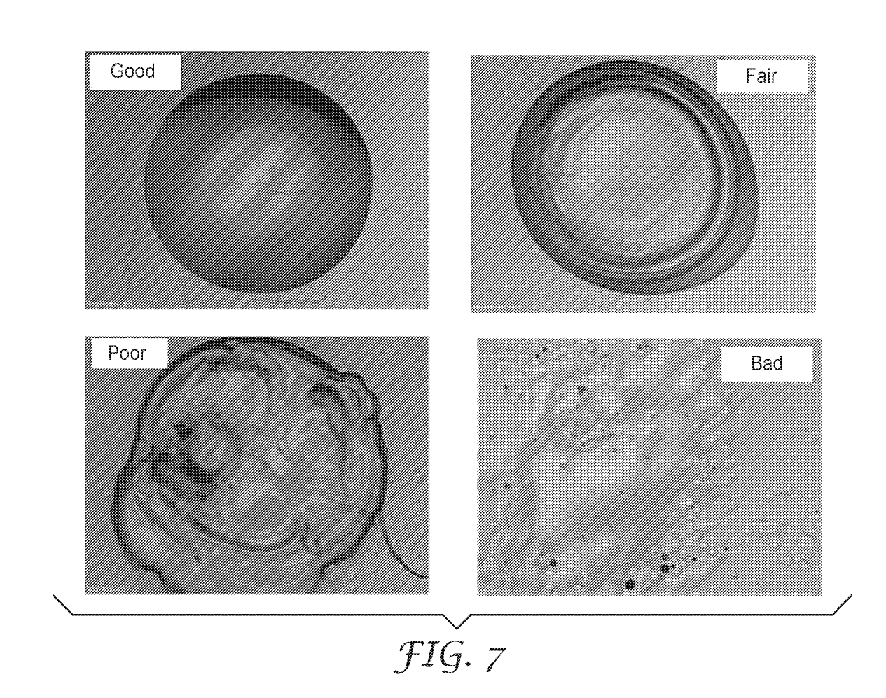

FIG. 6 illustrates the arrangement of nozzles 112 on a printer head 11 of a printing station such as the ink jet printing station 90 of FIG. 5, and the corresponding printed array 94 of adhesive composition on the web 22. The printed array 94 extends along the machine direction 222 with a width “W”. The printed quantities of adhesive composition are present in form of discrete dots each having an in-plane round shape and a cross-sectional dome shape as shown in FIG. 4. The pattern of the adhesive dots can be adjusted by arranging the nozzles 112 on the printer head 11. It is to be understood that, in some embodiments, the printed quantities of adhesive composition may be present as other shapes such as, for example, short intermittent stripes each of which may extend along the machine direction 222.

For the following Glossary of defined terms, these definitions shall be applied for the entire application, unless a different definition is provided in the claims or elsewhere in the specification.

### Glossary

Certain terms are used throughout the description and the claims that, while for the most part are well known, may require some explanation. It should be understood that:

The term “continuous” used herein refers to the length of a substrate web up to, for example, tens, hundreds, or even thousands of meters.

The terms “(co)polymer” or “(co)polymers” used herein refer to homopolymers and copolymers, as well as homopolymers or copolymers that may be formed in a miscible blend, e.g., by coextrusion or by reaction, including, e.g., transesterification.

The term “non-tacky” generally means that the microspheres have a tack value of less than about 5 grams, preferably less than about 3 grams, and more preferably less than about 1 gram, as measured using a texture tack analyzer.

The term “elastomeric” used herein can be described as applying to amorphous or non-crystalline materials that can be stretched to at least twice their original length (or diameter) and which will retract rapidly and forcibly to substantially their original dimensions upon release of the force.

As used herein, the term “repositionable” refers to the ability to be repeatedly adhered to and removed from a substrate without substantial loss of adhesion capability.

The term “release liner” used herein refers to a paper or plastic-based film sheet used to prevent a sticky surface from prematurely adhering, where it is coated on one or both sides with a release agent to provide a release effect against a sticky material such as an adhesive.

The terms “about” or “approximately” with reference to a numerical value or a shape means+/−five percent of the numerical value or property or characteristic, but expressly includes the exact numerical value. For example, a viscosity of “about” 1 Pa-sec refers to a viscosity from 0.95 to 1.05 Pa-sec, but also expressly includes a viscosity of exactly 1 Pa-sec. Similarly, a perimeter that is “substantially square” is intended to describe a geometric shape having four lateral edges in which each lateral edge has a length which is from 95% to 105% of the length of any other lateral edge, but which also includes a geometric shape in which each lateral edge has exactly the same length.

The term “substantially” with reference to a property or characteristic means that the property or characteristic is exhibited to a greater extent than the opposite of that property or characteristic is exhibited. For example, a substrate that is “substantially” transparent or optical clear refers to a substrate that transmits more radiation (e.g. visible light) than it fails to transmit (e.g. absorbs and reflects). Thus, a substrate that transmits more than 50% of the visible light incident upon its surface is substantially transparent, but a substrate that transmits 50% or less of the visible light incident upon its surface is not substantially transparent.

As used in this specification and the appended embodiments, the singular forms “a”, “an”, and “the” include plural referents unless the content clearly dictates otherwise. Thus, for example, reference to fine fibers containing “a compound” includes a mixture of two or more compounds. As used in this specification and the appended embodiments, the term “or” is generally employed in its sense including “and/or” unless the content clearly dictates otherwise.

As used in this specification, the recitation of numerical ranges by endpoints includes all numbers subsumed within that range (e.g. 1 to 5 includes 1, 1.5, 2, 2.75, 3, 3.8, 4, and 5).

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

Exemplary embodiments of the present disclosure may take on various modifications and alterations without departing from the spirit and scope of the present disclosure. Accordingly, it is to be understood that the embodiments of the present disclosure are not to be limited to the following described exemplary embodiments, but is to be controlled by the limitations set forth in the claims and any equivalents thereof.

Various exemplary embodiments of the disclosure will now be described with particular reference to the Drawings. Exemplary embodiments of the present disclosure may take on various modifications and alterations without departing from the spirit and scope of the disclosure. Accordingly, it is to be understood that the embodiments of the present disclosure are not to be limited to the following described exemplary embodiments, but are to be controlled by the limitations set forth in the claims and any equivalents thereof.

### LISTING OF EXEMPLARY EMBODIMENTS

Exemplary embodiments are listed below. It is to be understood that any one of embodiments 1-13, 14-21, and 22-24 can be combined.

Embodiment 1 is an article comprising:

a continuous web comprising a substrate having a first major side and a second major side opposite to the first major side, and at least two web edges;

one or more discrete quantities of adhesive disposed on one or both of the first and second major sides and adjacent to one or both of the web edges,

wherein the substrate is rolled upon itself in multiple revolutions, and

wherein each revolution is held substantially separate from the next by the one or more discrete quantities of adhesive.

Embodiment 2 is the article of embodiment 1, wherein the discrete quantities of adhesive include adhesive dots each having a dome shape.
Embodiment 3 is the article of embodiment 2, wherein the adhesive dots have an average height in the range from about 5 microns to about 2 mm.
Embodiment 4 is the article of any one of embodiments 1-3, wherein the adhesive have a cured ink composition with a glass transition temperature (Tg) no greater than about 25° C.
Embodiment 5 is the article of embodiment 4, wherein the cured ink composition includes one or more pressure sensitive adhesives (PSA).
Embodiment 6 is the article of embodiment 4 or 5, wherein the cured ink composition is obtained by curing a curable ink composition.
Embodiment 7 is the article of embodiment 6, wherein the curable ink composition comprises:

between about 50 to 99.89 parts by weight of hydroxyalkyl acrylate having 2 to 6 carbon alkyl;

between about 0 to 49.89 parts by weight of ethylenically unsaturated monomer including one or more of vinyl, acrylate, and (meth)acrylate monomer;

between about 0.01 to 5.0 parts by weight of a multi-functional acrylate or oligomer having (meth)acryl functional groups; and

between about 0.1 to 10 parts by weight of a photo-initiator.

Embodiment 8 is the article of embodiment 6 or 7, wherein the ink composition is curable by ultraviolet (UV) radiation.
Embodiment 9 is the article of any one of embodiments 6-8, wherein the curable ink composition has a viscosity of about 1 to about 50 mPa-s.
Embodiment 10 is the article of any one of embodiments 6-9, wherein the curable ink composition has a surface tension of about 20 to about 40 dyn/cm.
Embodiment 11 is the article of any one of embodiments 6-10, wherein the curable ink composition is ink-jet printable.
Embodiment 12 is the article of any one of embodiments 1-11, wherein the substrate includes a flexible polymeric film.
Embodiment 13 is the article of any one of embodiments 1-12, wherein the continuous web is a multi-layer optically clear laminate that includes a release liner, and the one or more discrete quantities of adhesive are disposed on a surface of the release liner along one or more of the web edges.
Embodiment 14 is a method of forming a wound web, comprising:

providing a continuous web comprising a substrate having a first major side and a second major side opposite to the first major side, and at least two web edges;

dispensing an ink composition in the form of one or more discrete quantities of adhesive on one or both of the first and second major sides and adjacent to one or both of the web edges;

curing the ink composition; and

winding the substrate upon itself in multiple revolutions,

wherein each revolution is held substantially separate from the next by the one or more discrete quantities of adhesive.

Embodiment 15 is the method of embodiment 14, wherein the adhesive has a glass transition temperature (Tg) no greater than about 25° C.
Embodiment 16 is the method of embodiment 14 or 15, wherein the substrate is wound in a roll-to-roll process with a winding tension not greater than 2 N/cm.
Embodiment 17 is the method of embodiment 16, wherein the winding tension is between 0.01 N/cm and 2 N/cm.
Embodiment 18 is the method of any one of embodiments 14-17, wherein the curable ink composition comprises:

between about 50 to 99.89 parts by weight of hydroxyalkyl acrylate having 2 to 6 carbon alkyl;

between about 0 to 49.89 parts by weight of ethylenically unsaturated monomer including one or more of vinyl, acrylate, and (meth)acrylate monomer;

between about 0.01 to 5.0 parts by weight of a multi-functional acrylate or oligomer having (meth)acryl functional groups; and

between about 0.1 to 10 parts by weight of a photo-initiator.

Embodiment 19 is the method of any one of embodiments 14-18, wherein the ink composition is cured by ultraviolet (UV) radiation.
Embodiment 20 is the method of any one of embodiments 14-19, wherein the ink composition has a viscosity of about 1 to about 50 mPa-s.
Embodiment 21 is the method of any one of embodiments 14-20, wherein the ink composition has a surface tension of about 20 to about 40 dyn/cm.
Embodiment 22 is an ink-jet printable composition of matter capable of being UV cured into a pressure sensitive adhesive, the composition comprising:

between about 50 to 99.89 parts by weight of hydroxyalkyl acrylate having 2 to 6 carbon alkyl;

between about 0 to 49.89 parts by weight of ethylenically unsaturated monomer including one or more of vinyl, acrylate, and (meth)acrylate monomer;

between about 0.01 to 5.0 parts by weight of a multi-functional acrylate or oligomer having (meth)acryl functional groups; and

between about 0.1 to 10 parts by weight of a photo-initiator,

wherein the viscosity of the composition is between about 1 to 50 mPa-s, and the surface tension of the composition is between about 20 to 40 dyn/cm.

Embodiment 23 is the composition of embodiment 22, wherein the hydroxyalkyl acrylate includes 4-hydroxybutyl acrylate (4-HBA).
Embodiment 24 is a method of forming an array of adhesive dots on a substrate, the method comprising:

providing the ink-jet printable composition of embodiment 22 or 23;

dispensing one or more discrete quantities of the ink-jet printable composition onto the substrate with an ink-jet printer; and

exposing the quantities of the ink-jet printable composition to UV radiation, forming the array of adhesive dots.

The operation of the present disclosure will be further described with regard to the following detailed examples. These examples are offered to further illustrate the various specific and preferred embodiments and techniques. It should be understood, however, that many variations and modifications may be made while remaining within the scope of the present disclosure.

### EXAMPLES

The compositions of the several Examples below are presented in Table 1.

TABLE 1
Examples of Ink-jet PSA (UV curable formulation)

| | Ex. | Ex. | Ex. | Ex. | Ex. | Ex. | Comp. | Comp. |
|---|---|---|---|---|---|---|---|---|
| | 1 | 2 | 3 | 4 | 5 | 6 | Ex. A | Ex. B |
| Acrylate | | | | | | | | |
| 4-HBA | 94.00 | 94.00 | 90.00 | 94.00 | 94.00 | 60.00 | | 44.00 |
| Lightacrylate | | | | | | | 94.00 | |
| P2HA | | | | | | | | |
| ISTA | | | | | | | | 50.00 |
| Placcel FA2D | | | | | | 40.00 | | |
| LA | 1.80 | 1.80 | | | | | 1.80 | |
| AA | 6.00 | 6.00 | | 6.00 | 6.00 | | 6.00 | 6.00 |
| HEAA | | | 10.00 | | | | | |
| Multi-functional | | | | | | | | |
| Acrylate | | | | | | | | |
| Lightacrylate | 0.20 | 0.20 | 0.20 | | | 0.20 | 0.20 | 0.20 |
| 1,6HX-A | | | | | | | | |
| NK Economer | | | | 2.00 | | | | |
| A-3070PER | | | | | | | | |
| NK Oligo | | | | | 2.00 | | | |
| UA-1013P | | | | | | | | |
| Photo-initiator | | | | | | | | |
| Irgacure. 2959 | 5.00 | | | | | | | |
| Irgacure. 127 | | 2.00 | 2.00 | 2.00 | 2.00 | 2.00 | 2.00 | 2.00 |
| Viscosity (mPa-s) | 25 | 21 | 25 | 22 | 28 | 33 | 27 | 24 |
| at 300/sec | | | | | | | | |
| Surface Tension | 36.1 | 35.9 | 37.7 | 36.7 | 35.7 | 38.5 | 37.7 | 26.9 |
| (dyn/cm) | | | | | | | | |
| Line Speed | | | | | | | | |
| 4 mpm | Good | Good | Good | Good | Good | Good | Good | Good |
| 12 mpm | Fair | Good | Good | Good | Good | Good | Poor | Poor |
| 20 mpm | Bad | Good | Good | Good | Good | Good | Bad | Bad |
| Tg* (° C.) | −26 | −26 | −23 | −26 | −26 | −35 | −19 | −25 |

*The value of Tg (glass transition temperature) is calculated by the Fox Equation as discussed in (Hiemenz, Paul; Timothy Lodge (2007). Polymer Chemistry. Boca Raton, Florida: CRC Press. ISBN 1-57444-779-3) which is hereby incorporated by reference as if rewritten.

More specifically, these materials are meant:

4-HBA: 4-hydroxybutyl acrylate commercially available from Osaka Organic Chemical Industries of Osaka, JP. (Tg=−32° C.);

Lightacrylate P2HA: Phenoxy polyethylene glycol (n=2) Acrylate commercially available from Kyoeisya Chemical Co. of Osaka, JP under the trade designation Lightacrylate P2HA (Tg=−25° C.);

ISTA: Iso-stearyl Acrylate commercially available from Osaka Organic Chemical Industries (Tg=−30° C.);

Placcel FA2D: Polycaprolactone (n=2) modified acrylate commercially available from Daicel Chemical of Osaka, JP. under the trade designation Placcel FA2D (Tg=−40° C.);

LA: Lauryl Acrylate commercially available from Osaka Organic Chemical Industries (Tg=15° C.);

Acrylic Acid: commercially available from Mitsubishi Chemical of Tokyo, JP. (Tg=106° C.);

HEAA: Hydroxyethyl Acrylamide commercially available from Kohjin of Tokyo, JP. (Tg=98° C.);

Lightacrylate 1,6HX-A: 1,6-Hexanediol Diacrylate commercially available from Kyoeisya Chemical under the trade designation Lightacrylate 1,6HX-A;

NK Economer A-3070PER: Polyethyleneoxide (n=51)−Polypropyleneoxide (m=13) Diacrylate (MW 3,000) commercially available from Shin-nakamura Chemical of Wakayama, JP under the trade designation NK Economer A-3070PER;

NK Oligo UA-1013P: Polypropyleneoxide Urethane Acrylate (MW 14,000) commercially available from Shin-nakamura Chemical under the trade designation NK Oligo UA-1013P;

Irgacure 2959: 1-[4-(2-Hydroxyethoxy)-phenyl]-2-hydroxy-2-methyl-1-propane-1-one as photo-initiator commercially available from BASF of Ludwigshafen, DE, under the trade designation Irgacure 2959; and

Irgacure 127: 2-Hydroxy-1-{4-[4-(2-hydroxy-2-methylpropionyl)benzyl]-phenyl}-2-methylpropane-1-one as photo-initiator commercially available from BASF under the trade designation Irgacure 127.

### Example 1

In Example 1, an apparatus generally as described in FIG. 5 was prepared, and a (co)polymeric film in the form of an indefinite length web 50 microns thick PET film having a width of 300 mm was threaded up in the unwind stand. An upper layer was applied by a slot die in the form of a hardcoat (2 microns thick) commercially available from Nippon Kayaku Co., Ltd. under the trade designation KAYANOVA. An adhesive layer (30 microns thick) made of a conventional acrylic pressure sensitive adhesive commercially available from Nippon Shokubai Co., Ltd under the trade designation of Aroset 8142 was applied by a conventional slot die. A release liner (25 microns thick) made of Silicone treated polyester film liner commercially available from Mitsui Chemicals Tohcello, Inc. under the trade designation SP-PET-O1-25BU was applied by the laminating station. The composition described as Example 1 in Table 1 was then applied to the release liner using an ink-jet printer head commercially available as REA JET from Rea Jet of Mühltal-Waschenbach, DE. This system was used to dispense fairly large size (54 nl drop volume) ink dots in an array onto the release liner. More specifically, the array comprised 6 dots/cm² in the zone within 10 mm of both web edges. The ink dots were cured into a pressure sensitive adhesive by a curing system employing H bulbs set to 240 W/cm commercially available as HERAEUS VPS from Heraeus Noblelight Fusion UV Inc. of Gaithersburg, Md. The curing operation was done under a nitrogen purge such that an oxygen concentration of under 900 ppm was present. After the curing, a wound-web article was formed by winding in on the wind-up stand with a tension of 5 N/300 mm (or 0.0167 N/mm) on the roll.

Three runs were performed, each at a different line speed. Line speeds of 4, 12, and 20 m/min were employed. Then, a portion of the web was unwound and the cured dots of PSA were observed by microscope. These were visually graded. FIG. 7 shows a visual guideline of the grades assigned after visual inspection in Table 1 above. It was observed that after a full curing, the shape of the cured dot was retained after winding.

### Examples 2-6

In Examples 2-6, the procedure of Example 1 was followed, save that the compositions called out on Table 1 were employed. Contrasting the outcome of these Examples with Example 1, it appears that the choice of photo-initiator has some bearing on the outcomes at faster line speeds.

### Comparative Example A

In Comparative Example A, the procedure of Example 1 was followed, save that the composition called out on Table 1 was employed. Contrasting the outcome of this Examples with Examples 2-6, it appears that the choice of calculated Tg of the final composition has some bearing on the outcomes at faster line speeds.

### Comparative Example B

In Comparative Example B, the procedure of Example 1 was followed, save that the composition called out on Table 1 was employed. Contrasting the outcome of this Examples with Examples 2-6, it appears that the choice of the amount of hydroxylated monomer in the final composition has some bearing on the outcomes at faster line speeds.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. In particular, as used herein, the recitation of numerical ranges by endpoints is intended to include all numbers subsumed within that range (e.g., 1 to 5 includes 1, 1.5, 2, 2.75, 3, 3.80, 4, and 5). In addition, all numbers used herein are assumed to be modified by the term “about.” Furthermore, all publications and patents referenced herein are incorporated by reference in their entirety to the same extent as if each individual publication or patent was specifically and individually indicated to be incorporated by reference. Various exemplary embodiments have been described. These and other embodiments are within the scope of the following claims.

1. An article comprising:
a continuous web comprising a substrate having a first major side and a second major side opposite to the first major side, and at least two web edges; and
one or more discrete quantities of adhesive disposed on one or both of the first and second major sides and adjacent to one or both of the web edges,
wherein the substrate is rolled upon itself in multiple revolutions, and
wherein each revolution is held substantially separate from the next by the one or more stripes of adhesive dots.

2. The article of claim 1, wherein the discrete quantities of adhesive include adhesive dots each having a dome shape.

3. The article of claim 1, wherein the adhesive has a cured ink composition with a glass transition temperature (Tg) no greater than about 25° C.

4. The article of claim 3, wherein the cured ink composition includes one or more pressure sensitive adhesives (PSA).

5. The article of claim 3, wherein the cured ink composition is obtained by curing a curable ink composition.

6. The article of claim 5, wherein the curable ink composition comprises:
between about 50 to 99.89 parts by weight of hydroxyalkyl acrylate having 2 to 6 carbon alkyl;
between about 0 to 49.89 parts by weight of ethylenically unsaturated monomer including one or more of vinyl, acrylate, and (meth)acrylate monomer;
between about 0.01 to 5.0 parts by weight of a multi-functional acrylate or oligomer having (meth)acryl functional groups; and
between about 0.1 to 10 parts by weight of a photo-initiator.

7. The article of claim 5, wherein the ink composition is curable by ultraviolet (UV) light.

8. The article of claim 5, wherein the curable ink composition has a viscosity of about 1 to about 50 mPa-s.

9. The article of claim 5, wherein the curable ink composition has a surface tension of about 20 to about 40 dyn/cm.

10. The article of claim 5, wherein the curable ink composition is ink-jet printable.

11. The article of claim 1, wherein the substrate includes a flexible polymeric film.

12. The article of claim 1, wherein the continuous web is a multi-layer optically clear laminate that includes a release liner, and the one or more stripes of adhesive dots are disposed on a surface of the release liner along one or more of the web edges.

13. A method of forming a wound web, comprising:
providing a continuous web comprising a substrate having a first major side and a second major side opposite to the first major side, and at least two web edges;
dispensing a curable ink composition in discrete quantities on one or both of the first and second major sides and adjacent to one or both of the web edges;
curing the ink composition to form one or more discrete quantities of adhesive; and
winding the substrate upon itself in multiple revolutions,
wherein each revolution is held substantially separate from the next by the one or more discrete quantities of adhesive.

14. The method of claim 13, wherein the substrate is wound in a roll-to-roll process with a winding tension not greater than 2 N/cm.

15. An ink-jet printable composition of matter capable of being UV cured into a pressure sensitive adhesive, the composition comprising:
between about 50 to 99.89 parts by weight of hydroxyalkyl acrylate having 2 to 6 carbon alkyl;
between about 0 to 49.89 parts by weight of ethylenically unsaturated monomer including one or more of vinyl, acrylate, and (meth)acrylate monomer;
between about 0.01 to 5.0 parts by weight of a multi-functional acrylate or oligomer having (meth)acryl functional groups; and
between about 0.1 to 10 parts by weight of a photo-initiator,
wherein the viscosity of the composition is between about 1 to 50 mPa-s, and the surface tension of the composition is between about 20 to 40 dyn/cm.

16. The composition of claim 15, wherein the hydroxyalkyl acrylate includes 4-hydroxybutyl acrylate (4-HBA).
